(19) United States
(12) Patent Application Publication
(10) Pub. No.: US 2014/0302478 A1
(43) Pub. Date: Oct. 9, 2014

(54) CENTRALIZED TRAINING EXERCISE CONTROL PROCESS

(71) Applicant: Tom Joseph Evans, Kaysville, UT (US)

(72) Inventor: Tom Joseph Evans, Kaysville, UT (US)

(21) Appl. No.: 14/209,721

(22) Filed: Mar. 13, 2014

Related U.S. Application Data
(60) Provisional application No. 61/781,701, filed on Mar. 14, 2013.

(51) Int. Cl. G09B 5/08

(52) U.S. Cl. CPC G09B 5/08
USPC 434/362

(57) ABSTRACT

A method to conduct operations-based training exercises is described herein including one or more control groups, one or more observation groups and one or more training audiences subjected to implementer and/or injects, the method comprising the one or more control groups directing the one or more observation groups to specific positions by utilizing real time communication, the one or more observation groups observing the one or more training audiences and recording observations, the one or more observation groups uploading the observations to a database accessible by the one or more control groups, and the one or more control groups retrieving and analyzing the observations and, optionally, modifying the operations-based training exercises.

### FIELD OF THE INVENTION

The present invention is in the technical field of training exercise planning and execution of Operation-Based Exercises at the local, tribal, state, federal, military, and international levels.

### BACKGROUND

Operations-based exercises are planned and executed using a notional scenario that is designed to meet specific training or exercise objectives. This scenario is broken down into a series of injects and implementers that are inserted into the training audience to direct training audience actions. Activity of the training audience in response to injects and implementers is captured by observers who report observations for analysis. An observer's ability to capture observations is based on his/her understanding of training audience tactics, techniques and procedures, which generates a list of expected actions of the training audience in response to the scenario injects and implementers. The exercise analysis process determines if training objectives were met, evaluates training audience performance, determines if plans, policies and procedures are valid, and creates a new set of training objectives for the next exercise. During the execution of an operations-based exercise, observations of training-audience activities are captured on paper and collected for submission to those responsible for analysis. Often, the collection and submission process occurs once or twice a day. Or observers submit observations for analysis after the end of the exercise. In these cases, the analysis process usually starts days after the beginning of the exercise (or after the exercise is complete) and the ability for exercise controllers to use information from observers to dynamically change the exercise to meet exercise objectives doesn't exist.

### SUMMARY OF THE EMBODIMENTS OF THE INVENTION

A method to conduct operations-based training exercises is described herein including one or more control groups, one or more observation groups and one or more training audiences subjected to implementer and/or injects, the method comprising the one or more control groups directing the one or more observation groups to specific positions by utilizing real time communication, the one or more observation groups observing the one or more training audiences and recording observations, the one or more observation groups uploading the observations to a database accessible by the one or more control groups, and the one or more control groups retrieving and analyzing the observations and, optionally, modifying the operations-based training exercises.

Also described is a computer generated application for conducting operations-based training exercises including a communications module for establishing real time communication between a control group and an observation group, an observation module for allowing a member of the observation group to record observations electronically, a database module for allowing the uploading and downloading of observations and instructions to and from a database, an analysis module for analyzing and comparing performances of one or more training audiences, and an implementation module for communicating dynamic changes to the training exercises.

A method for conducting operations-based training exercises is also described, the method includes directing an observation group to specific positions at specific times in real time, providing operation details to the observation group in real time, observing a training audience being subjected to implementers and injects, recording the observations in electronic form, uploading the observations to a database, retrieving the observations from the database, analyzing the observations, and implementing dynamic changes to the training exercises in real time.

### DETAILED DESCRIPTION OF THE EMBODIMENTS OF THE INVENTION

Referring now to the embodiments of the invention in more detail, the process may involve mobile device applications, as for example, iPad and/or iPhone applications, that may be developed to run on the current operating system(s) for each device. As defined herein, mobile devices may include Android, BlackBerry 10, iOS, S40, Windows Phone, Windows 8, Windows RT, bada, BlackBerry OS, BlackBerry Tablet OS, GridOS, Linux, Mer project, Brew, SHR, Symbian OS, webOS, Windows Mobile, Palm OS, Aliyun OS, Firefox OS, Sailfish OS, and Ubuntu Phone. As defined herein, operating system(s) may include software that communicates with hardware and allows other programs or applications to run. The embodiment may utilize these applications to allow for the centralized, and when necessary remote, control, observation collection and analysis of local, tribal, state, federal and international operations-based training exercises.

Furthermore, according to some aspects, observations may be collected from remote locations where training audiences are exercising to be gathered into a centralized database in real time. In other embodiments, real-time analysis of observations may be performed by the centralized, remote exercise control group to determine if exercise objectives are being met. If it is determined that the exercise objectives are not being met, dynamic changes to the exercise Master Scenario Events List (MSEL) may be made, and those changes may be communicated to observers so that they can make adjustments to match expected training audience actions to observe. As defined herein, expected training audience actions may include actions performed by the training audience that are consistent with the training audience's policies, plans and procedures. According to some embodiments, the analysis of training audience actions may lead to real-time preparations of an After Action Report and Corrective Action Plan.

In some embodiments, the centralized exercise control group may direct observers in distributed locations to positions where training audience activities are occurring in response to the MSEL injects and implementers. These directions may inform the observer of the location and time of the expected training audience action, as well as the details of what the expected action may be in response to the MSEL injects and implementers. The direction may also include a performance standard, by which the expected action of the training audience is to be evaluated.

As the observer watches the training audience perform tasks, in response to injects and implementers from the MSEL, an observation may be recorded using embodiment. This embodiment may include the capability to provide guidance on what the exercise objective is for each particular observation, as well as a means to gather the specific observation, any discussion that the observer needs to include for clarification and context, and any recommendations to the training audience. The data collected may be uploaded, in real time, to a database that resides with the centralized exercise control group. The centralized exercise control group may be made aware of training audience performance immediately, allowing for real-time analysis of the effectiveness of the designed scenario and MSEL, and where necessary, make adjustments to guide the training audience to meet exercise objectives.

If the real-time analysis of training audience activities in response MSEL injects and implementers determines that exercise objectives are not being met, the centralized exercise control group has the option to modify the scenario, and corresponding MSEL, resynchronize the MSEL to verify the validity and coherence of the dynamic changes and stimulate the training audience with improved injects and implementers. In some embodiments, software applications may be utilized to direct observers to locations where expected training audience activity will occur. This may ensure that dynamic changes to the MSEL will not result in training audience activity that is not observed and analyzed.

According to some embodiments, a real-time feedback loop between the centralized exercise control group, members of the observation team and the analysis cells may be generated. It may allow the centralized control group to be located in a location remote from distributed training audience locations, resulting in cost savings and easier operational set up. It also may ensure that exercise objectives are met, and may enhance the analysis process for the rapid development of an After Action Report, Corrective Action Plan and a new set of training objectives for the beginning of the next exercise life cycle.

According to some embodiments of the invention, a method to conduct operations-based training exercises. As defined herein, operations-based exercises may include drills, which validate a single operation or function of an agency, Functional Exercises (FE), which evaluate capabilities functions, plans, and staffs of Incident Command, Unified Command, Operations Command, Joint Operations Command, intelligence centers, and other multi-agency coordination centers (e.g. EOCs), and Full-Scale Exercises (FSE), which validate plans, policies, procedures, and cooperative agreements developed in previous exercises through there actual implementation and execution during a simulated scenario; includes actual mobilization of resources, conduct of operations, and interagency elements of functional exercise play (e.g., EOCs, command posts) including a one or more centrally located or remotely distributed control groups. As defined herein, centrally or remotely distributed control groups may include the group of controllers in a single, centralized location, or in distributed locations that are geographically close or distant from the training audience, that plan and manage exercise play, set up and operate the exercise incident site, and possible take roles of individuals and agencies not actually participating in the exercise, (i.e., in the Simulation Cell), one or more observation groups. As defined herein, observation groups may include groups of individual observers that view selected segments of exercise as it unfolds, while remaining separated from player activities, and one or more training audiences. As define herein, training audiences may include players that have an active role in responding to risks and hazards presented in the exercise scenario by performing their regular roles and responsibilities, when subjected to injects and/or implementers. As defined herein, injects and/or implementers may include written, oral, televised, and/or transmitted via any means (e.g., fax, phone, e-mail, voice, radio or sign) directives instructions or decisions to drive exercise play towards the achievement of exercise objectives. The one or more control groups may direct the one or more observation groups to specific positions, using GPS and/or map coordinates, by utilizing real time communication. According to some embodiments, real time communication may include communication that can be transmitted and received instantly or almost instantly (with consideration to network latency). In certain embodiments, real time communication may include but is not limited to instant messenger communication, voice chat, video chat, text messages, phone communications, radio communication, and voice mail. Additionally, in some embodiments, the one or more observation groups observe the one or more training audiences and record observations. According to some aspects, recorded observations may include a record of the actions of the training audience, a detailed description of how those actions compare with plans, policies and procedures of the training audience, and any recommendation on how improvements may be made. The one or more observation groups may upload the observations to a database accessible by the one or more control groups. According to some embodiments, upload may include the transfer of data to a larger computer system or database. In some embodiments, database may include a structured set of data held on a computer. The one or more control groups may retrieving and analyze the observations and, optionally, modify, or make dynamic changes to the operations-based training exercises. In certain embodiments, retrieving may include copying data from one computer to another or to a disk. In some embodiments, analyzing may include evaluating data regarding training audience performance against plans, policies, procedures and/or accepted practices and/or standards. In certain embodiments, modifying or making dynamic changes to, may include the adjustment, deletion or creation of portions of the exercise scenario, timeline, MSEL and/or individual or combined injects and/or implementers as the exercise is being executed. The embodiments may allow for the resynchronization of the MSEL during exercise execution in response to modifications. In some embodiments, resynchronizing may include adjusting the order and timing of MSEL injects so that they occur in a predetermined order or rate. According to some embodiments a real time feedback loop may be generated between the control groups and observation groups, through the use of one or more software applications. In some embodiments, real time feedback loop may include instantaneous or almost instantaneous (with consideration to network latency) control system that allows for feedback and correction, and that adjusts according to the differences between the actual output and the desired output. In some embodiments, software application may include software programs that will run on computers that have a single application for the user.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

### EXAMPLES

Examples of how the embodiment may be utilized to save money over traditional operations-based exercise control, observation analysis process include establishing a centralized, remote control group that does not require the cost, planning and logistical support of a control group that has been assembled and relocated to a location geographically near the activities of the training audience. The embodiment may be used by the control group to direct observers to specific locations where the expected actions of the training audience will occur. This ensures that the collective knowledge and experience of the control group, and not that of individual observers who may or may not have adequate experience, is directing the observation process. Real-time feedback between observers and controllers allows controllers to ensure that exercise objectives are met as the exercise is executed, resulting in the highest value for money spent to plan, assemble participants and execute an operations-based training exercise. Utilization of the embodiment may result in real-time or near real-time analysis of training audience performance, improving the quality of the after-action review process, the development of any corrective-action plans, and the creation of new exercise objectives for the next exercise planning process. Utilization of the embodiment may allow all these things to occur during exercise execution and not after the end of the exercise, saving time and money.

1. A method to conduct operations-based training exercises including a one or more control groups, one or more observation groups and one or more training audiences subjected to implementers and/or injects, the method comprising:
the one or more control groups directing the one or more observation groups to specific positions by utilizing real time communication;
the one or more observation groups observing the one or more training audiences and recording observations;
the one or more observation groups uploading the observations to a database accessible by the one or more control groups; and
the one or more control groups retrieving and analyzing the observations and, optionally, modifying the operations-based training exercises.

2. The method of claim 1, wherein modifying the operations-based training exercises comprises modifying the training scenarios, adding or removing implementers and/or injects, and/or resynchronizing the training scenario.

3. The method of claim 1, wherein the one or more control groups oversee the operations-based training exercise by utilizing a real time feedback loop.

4. The method of claim 1, wherein the one or more control groups are remote.

5. The method of claim 1, wherein the one or more control groups are centralized.

6. The method of claim 1, wherein the one or more control groups directing the one or more observation groups to specific positions comprises the one or more control groups directing the one or more observation groups to specific distributed locations at specific times.

7. The method of claim 1, further comprising evaluating the performance of the training audiences based on the real time feedback received by the observation groups.

8. The method of claim 1, wherein the real time communication between the one or more control groups and the one or more observation groups is established by a software application.

9. The method of claim 1, wherein the one or more observation groups record observations by utilizing a software application.

10. The method of claim 1, wherein the one or more observation groups upload the observations to a database by utilizing a software application.

11. The method of claim 1, wherein the one or more control groups retrieving and analyzing the observations and, optionally, modifying the operations-based training exercises comprises the one or more control groups retrieving and analyzing the observations and, optionally, modifying the operation-based training exercises by utilizing a software application.

12. The method of claim 1 further comprising utilizing a software application, wherein the software application establishes communication between the one or more control groups and the one or more observation groups, allows for recording of observations, uploads observations to a database, downloads observations from the database, allows for dynamic changes to the training scenarios.

13. The method of claim 1, wherein the software application is an application developed for an operating system selected from the group consisting of Android, BlackBerry 10, iOS, S40, Windows Phone, Windows 8, Windows RT, bada, BlackBerry OS, BlackBerry Tablet OS, GridOS, Linux, Mer project, Brew, SHR, Symbian OS, webOS, Windows Mobile, Palm OS, Aliyun OS, Firefox OS, Sailfish OS, and Ubuntu Phone.

14. The method of claim 1, wherein the software application is an application developed for a mobile device.

15. The method of claim 1, wherein the software application is an application developed for an iPad or iPod.

16. The method of claim 1, further comprising the one or more control groups providing information to the one or more observation groups detailing expected training audience actions by the one or more training audiences to the implementers and injects.

17. The method of claim 1, wherein real time communication comprises utilizing a software application to relay messages to and from the control group via email, instant messenger, electronic chat communication, voice mail, video chat.

18. The method of claim 1, wherein the observation group may be observing the training audiences in person or through the use of cameras in the field, mobile cameras, or satellite.

19. A computer generated application for conducting operations-based training exercises comprising:
a communications module for establishing real time communication between a control group and an observation group;
an observation module for allowing a member of the observation group to record observations electronically;
a database module for allowing the uploading and downloading of observations and instructions to and from a database;
an analysis module for analyzing and comparing performances of one or more training audiences with established plans, policies and procedures; and
an implementation module for communicating dynamic changes to the training exercises.

20. A method to conduct operations-based training exercises, the method comprising:
directing an observation group to specific positions at specific times in real time;
providing operation details to the observation group in real time;
observing a training audience being subjected to implementers and injects;
recording the observations in electronic form;
uploading the observations to a database;
retrieving the observations from the database;
analyzing the observations; and
implementing dynamic changes to the training exercises in real time;
